(19) United States
(12) Patent Application Publication
(10) Pub. No.: US 2020/0336411 A1
(43) Pub. Date: Oct. 22, 2020

(54) MANAGEMENT OF THE CONNECTION WITH OTHER RESIDENTIAL GATEWAYS OF A RESIDENTIAL GATEWAY IMPLEMENTING LINK AGGREGATION

(71) Applicant: SAGEMCOM BROADBAND SAS, RUEIL MALMAISON (FR)

(72) Inventor: Simon BATARDIÈRE, RUEIL MALMAISON (FR)

(21) Appl. No.: 16/756,658

(22) PCT Filed: Oct. 12, 2018
(86) PCT No.: PCT/EP2018/077924

§ 371 Date: Apr. 16, 2020

(30) Foreign Application Priority Data
Oct. 17, 2017 (FR) 1759746

(51) Int. Cl. H04L 12/709; H04L 12/717; H04L 12/801; H04L 12/28; H04L 12/54; H04L 12/24; H04L 29/06

(52) U.S. Cl. CPC H04L 45/245; H04L 45/42; H04L 47/193; H04L 69/22; H04L 12/5692; H04L 41/0816; H04L 12/2865

(57) ABSTRACT

A method for managing the connection to other devices of a network device such as a residential gateway, is presented. The method prevents the other devices from being offered the ability to perform aggregation via the device which implements the method if this device itself performs link aggregation with other devices in order to increase its bandwidth. One thus avoids stream crossovers which reduce to naught the benefit of performing link aggregation between several residential gateways.

### TECHNICAL FIELD

The present invention pertains, generally speaking, to the management of connections in a residential gateway implementing link aggregation, for the establishment of a single multi-path connection between two computer devices or computer network devices.

It more particularly relates to a data routing method, and a device and an associated computer programme product, for use in a residential gateway while implementing link aggregation.

The invention finds applications, in particular, in residential gateways that connect domestic computer networks to the Internet.

### TECHNOLOGICAL BACKGROUND

Link aggregation (also called “bonding”) is a technique used in computer networks such as Ethernet networks, for the routing of IPv4 (Internet Protocol version 4) or IPv6 (Internet Protocol version 6) packets, for example. It may be defined as the aggregation of several network interfaces into a single logic interface so as to increase the bandwidth and provide redundancy for a connection between two determined devices. For example, it may be used to increase the throughput of a TCP (Transmission Control Protocol) connection in a WAN (Wide Area Network), as opposed to the LAN (Local Area Network).

In IP (Internet Protocol) networks, it is usually set up between the ports of Ethernet switches in the Internet network, or between Ethernet cards of computers operating under Linux, Unix or Windows. In this context, it makes it possible to group together several network ports and to use them as if it was a single port. It responds to two problems in networks, namely the limitation in bandwidth between two devices, on the one hand, and the absence of redundancy of links, on the other hand. Link aggregation indeed makes it possible to increase throughput beyond the limits of a single link, and potentially to ensure that the other ports take over if a link breaks down. However, aggregation is a general concept that can be implemented in each of the three lower layers of the OSI (Open Systems Interconnection) model.

In the context of the present invention, the aggregation of different links makes it possible to increase the throughput of a “residential gateway” by using simultaneously the capacities of a plurality of DSL (Digital Subscriber Line) links, respectively associated with a plurality of residential gateways and via which each residential gateway may communicate with the Internet. Aggregation uses other links established between the residential gateways. Typically, DSL and Ethernet links to the WAN (typically to the Internet) are established through a DSL interface and through an Ethernet interface, respectively, of the residential gateway, whereas a link to the WAN through another residential gateway is established for example via a Wi-Fi interface (IEEE 802.11 or ISO/CEI 8802-11 norms), although these examples are not exclusive. For example, an optical link may also be used by the residential gateway for its link with the WAN.

“Residential gateway” or CPE (Customer Premises Equipment) is taken to mean a terminal hardware device which is located in the site of a client (private individual or company), and which is connected on the one hand to a local LAN loop and on the other hand to the infrastructure of an Internet Service Provider (ISP) in a POP (Point Of Presence). It is the terminal device on the side of the client which is used to connect to the Internet network. This device is also commonly called a “box”.

### PRIOR ART

The aggregation of different links is per se a technique already known and rolled out. Numerous technologies enable it to be implemented, such as for example the set of extensions of the TCP specification known as “Multipath TCP” or MPTCP, or instead Generic Routing Encapsulation (GRE). The basic idea behind link aggregation such as implemented, for example, in the MPTCP protocol defined in RFC 6824 of the IETF, is to establish a link between a source host and a destination host and no longer between two interfaces as is the case in the standard Transmission Control Protocol (TCP).

The MPTCP is a continuous effort of the IETF (Internet Engineering Task Force) which aims to allow a TCP to use several access paths in order to maximise the use of resources and to increase redundancy while remaining compatible with current devices (firewall, NAT, etc.) of the Internet. A client can rely on this protocol to connect to a same destination host via several connections on different network adaptors, thus creating reliable and efficient data connections between the source host and the destination host which interact with the existing network infrastructures. MPTCP thus makes it possible to establish and to use a same and single TCP connection through several network interfaces. The typical case of use consists in discharging 4G networks (or LTE for Long Term Evolution, namely the global standard for fourth generation wireless services) via the Wi-Fi, which makes it possible to use a public Wi-Fi terminal or access point (hot spot) when the terminal is within radio range of this terminal, and to return in a transparent manner exclusively to the 4G network from the moment that the terminal is no longer within range. Another application is the sharing of several links (for example, two Ethernet cables) for a server in a transparent manner.

The interest of MPTCP is indeed to be totally transparent for the applications. Unlike the linking of Ethernet channels using link aggregation according to the IEEE 802.3ad LACP (Link Aggregation Control Protocol), for example, Multipath TCP can balance a single and unique TCP connection through multiple interfaces. An implementation both on the client side and on the server side suffices for this to be possible. In January 2013, the IETF published the specifications of Multipath TCP as an experimental norm in RFC 6824.

GRE is for its part a tunnelling protocol which makes it possible to encapsulate any packet of the network layer. The original packet is the useful information (payload) of the final packet. For example, servers that wish to set up tunnels can use GRE through the Internet to create virtual private networks. The GRE protocol corresponds to the code 47 in the field “protocol” in a header of an IPv4 data packet, or the field “next header” of the final header of an IPv6 data packet.

All of these technologies require having an aggregation point deployed in the network core, in order to reconstitute in the network the stream of data from the sub-streams respectively received by each of the aggregated links.

However, known implementations of these technologies are essentially limited to aggregation of multiple WAN links of a residential gateway. Hence, they do not take into consideration the problems that can be raised by the implementation of WAN links of different respective residential gateways, which are accessible one by the other through links enabling several gateways to communicate with each other. Such links are for example offered in the topologies of mesh networks (wired or not) of MESH type. They may also be wireless links, offered in community Wi-Fi.

The aforementioned problems notably comprise problems of data crosstalk, which are prejudicial to the efficiency of the system. Indeed, there is an increase in latency and complexity if two gateways mutually perform this aggregation operation from one to the other and vice versa. For example, if a first gateway sends a part of its traffic to a second gateway in order to increase its throughput, and that, said second gateway does the same thing by sending a part of its traffic to the first gateway, then neither the overall traffic, nor the traffic for each of the gateways is increased. Performing a link aggregation in these circumstances is thus inefficient and only has drawbacks.

Furthermore, different routing protocols exist which make it possible to determine the optimal path to a given destination host. It is possible to cite for example the OLSR (Optimized Link State Routing) protocol. according to RFC 36263 of the IETF (Internet Engineering Task Force), the RIP (Routing Information Protocol) which allows routers that interconnect networks via IP (Internet Protocol) to share information relative to the delivery of traffic between these different networks. However, these routing protocols are suited to finding the optimal link, whereas aggregation techniques are suited to seeking to use all possible links. It follows that these protocols do not provide any solution to resolve the aforesaid problems of data crosstalk.

### SUMMARY OF THE INVENTION

The invention makes it possible to resolve a problem posed by link aggregation or “bonding”, which is the risk of creation of crosstalk between two residential gateways (CPE) that implement this technology.

The invention aims to eliminate, or at least to attenuate, all or part of the aforesaid drawbacks of the prior art while avoiding the creation of crossed streams which affects the interest of performing link aggregation between several residential gateways, for example.

To this end, a first aspect of the invention proposes a method for managing the connection of a first network device with at least one second network device of a data network, each of said first and second network devices comprising a link aggregation engine implementing a link aggregation technique to select one from among at least a first and a second outbound links participating in link aggregation in said network device with:
an outbound link for connecting said network device to the other network device; and
at least one other outbound link which is capable of reaching a determined aggregation point in the data network without passing through the other network device,
the method comprising the following steps, implemented in the first network device:
i. decision by the aggregation engine of the first network device to send data on the outbound link of said first network device which connects it to the second network device;
ii. detecting whether data from the second network device or another network device are received, via the outbound link of said second network device and/or the other network device which connects it to the first network device, in the context of a link aggregation implemented in said second network device and/or in the other network device, on the basis of markers present in said data; then,
iii. in the affirmative, closing the outbound link of the second network device and/or the other network device which connects it to the first network device; and,
iv. transmission of data on the outbound link connecting the first network device to the second network device in the context of the link aggregation implemented in the first network device.

Briefly, the method prevents other devices from being offered the ability to perform aggregation via the device that implements the method if this device itself performs aggregation with other devices in order to increase its bandwidth. One thus avoids the crosstalk behind the aforementioned drawbacks.

In an embodiment, the method may further comprise the determination by the first network device, when any new network device tries to connect to said first network device, of whether data may be received from said new network device in application of a link aggregation implemented in said new network device, on the basis of one or more markers in the data received from said new device in the context of the procedure of establishing the connection of said new network device to the first network device, or on the basis of one or more markers in the data received from said new network device once said connection has been established.

For example, if the new network device tries to connect to the first network device while said first network device implements link aggregation, and if it is determined that data may be received from said new network device in application of a link aggregation implemented in said new device, then the connection of the new network device to the first network device may be denied or be closed in the case where said connection is already established at the moment when the aforesaid determination occurs.

In an embodiment, wherein the second network device and/or the other network device and/or the new device network use the MPTCP protocol for link aggregation, a marker used may be the presence of the option TCP 30 “muitipath TCP” in the data received by the first network device, originating from the second network device or the other network device or the new network device, respectively.

In another embodiment, wherein the second network device and/or the other network device and/or the new device network use GRE tunnels for link aggregation, a marker used may be the value 47 in the field “protocol” in a header of an IPv4 data packet, or the field “next header” of the final header of an IPv6 data packet, comprised in the data received by the first network device, originating from the second network device or the other network device or the new network device, respectively.

In one and/or the other of the above two embodiments, it is further possible to test the nature of the interface through which are received, by the first network device. data received from the second device network and/or the other network device and/or the new network device. This makes it possible to lift the limitations linked to the fact that MPTCP or GRE, respectively, could have been used in the second network device or in the new network device in a context other than link aggregation.

In other embodiments, a marker used may comprise the destination IP address of a data packet comprised in the data received from the second network device or the other network device or the new network device with the IP addresses contained in a list of IP addresses of the aggregation point and known to the first network device.

In an alternative or a complement, a marker used may comprise a unique identifier, known by the first network device, the second network device and/or the other network device and/or the new network device.

In such a case, the unique identifier of the second network device or the other network device or the new network device may comprise a physical address in the network which is specific to said second network device or to the other network device or to the new network device, respectively, and which is known to the first network device either in a static manner or in a dynamic manner because it is communicated to said first network device by a network management protocol. In this case, the test of the identifier comprises the comparison with an interval of physical addresses known to the first network device.

When the data are received from the second network device or the new network device via a Wi-Fi IEEE 802.11 interface of the first network device, a marker used may comprise a specific value in the attribute number 26 of a frame of type probe request.

Finally, in an embodiment wherein the first network device (CPE1) plays the role of DHCP server vis-a-vis the second network device (CPE2) and/or vis-a-vis the other network device and/or vis-a-vis the new network device, a marker used may be a DHCP option with a predefined value known to the first network device, the second network device and/or the other network device and/or the new network device, which is inserted by the second network device or by the other network device or by the new network device, respectively, in the data received by the first network device from said second network device or said other network device or said new network device, respectively, when these data are the subject of a link aggregation in said second network device or in said other network device or in said new network device, respectively.

In a second aspect, the invention relates to a device for managing the connection of a first network device with at least one second network device, each of said first and second network devices comprising a link aggregation engine implementing a link aggregation technique to select one from among at least a first and a second outbound links participating in link aggregation in said network device with:
an outbound link for connecting said network device to the other network device; and
at least one other outbound link which is capable of reaching an aggregation point in the network without passing through the other network device, the device comprising, within the first network device:
i. means in the aggregation engine to decide to send data on the outbound link of said first network device which connects it to the second network device;
ii. means for detecting whether data from the second device or another network device are received, via the outbound link of said second network device and/or the other network device which connects it to the first network device, in the context of a link aggregation implemented in said second network device and/or in said other network device, on the basis of markers present in said data; then,
iii. means for, in the affirmative, closing the outbound link of the second network device and/or the other network device which connects it to the first network device; and,
iv. means for transmitting data on the outbound link connecting the first network device to the second network device in the context of link aggregation implemented in the first network device.

In a third aspect, the invention also relates to a residential gateway comprising a device according to the second aspect.

In a fourth aspect, the invention further relates to a “computer programme” product directly loadable in the internal memory of a digital computer, comprising software code portions which, when said programme is executed by a computer, lead said computer to implement all the steps of the method according to the first aspect above. More particularly, the computer programme product comprises one or more sequences of instructions stored on a memory support readable by a machine comprising a processor, said sequences of instructions being suited to carrying out all the steps of the method according to the first aspect of the invention when the programme is read in the memory support and executed by the processor.

A fifth aspect of the invention finally relates to a data recording support readable by a machine comprising a processor (i.e., a computer), comprising the programme according to the fourth aspect. Such a recording support may be an optical recording support such as a CDrom or a DVDrom, a magnetic recording support such as a computer hard disc, an electrically readable electronic memory such as an EPROM, an EEPROM, a DRAM memory, a Flash memory, etc.

### BRIEF DESCRIPTION OF THE DRAWINGS

Other characteristics and advantages of the invention will become clearer on reading the description that follows. This is purely illustrative and must be read with regard to the appended drawings in which:

FIG. 1 is a functional diagram showing an example of residential gateway implementing the aggregation of two links for the communication between a domestic network and the Internet, for example;

FIGS. 2A-20 illustrate the different paths that data coming from two residential gateways such as that of FIG. 1 can follow to reach the Internet, respectively when neither of the two gateways, when a single one of the two gateways or when both of the two gateways implement link aggregation;

FIGS. 3A-3D are diagrams illustrating different configurations liable to give rise to crosstalk between two residential gateways, or more, such as the residential gateway of FIG. 1;

FIG. 4 is a simplified diagram of another example of residential gateway with more than two links eligible for link aggregation; and,

FIG. 5 is a diagram of states and a diagram of steps which illustrates embodiments of the method according to the invention; and,

FIGS. 6A-6C are diagrams illustrating different cases of use of the method, by comparing each time the situation without the implementation of the method (on the left) with the situation with the implementation of the method (on the right).

### DETAILED DESCRIPTION OF EMBODIMENTS

In the description of embodiments that follows and in the appended Figures of the drawings, the same elements or similar elements bear the same numerical references in the drawings.

As has been described in the introduction, different technologies use the concept of link aggregation between devices of a network (for example commutators or routers), or between a device (for example a computer) and a network, in order notably to increase throughput beyond the limits that are reached with a single link. These existing techniques may be implemented in each of the three lower layers of the OSI model.

There is for example the aggregation of physical Ethernet links via “Channel Bonding” between two routers of a network, which the network layer of the OSI model only sees as a single logic communication channel. Another example is given by the sharing of several links (for example, two Ethernet cables) for the connection of a computer with a server in a transparent manner. On a wireless network, according to another example, a device may combine several frequency ranges into a single one, more extended. Thus for example, in IEEE 802.11n, an operating mode with a frequency range extending over 40 MHz is defined. This unique channel uses two adjacent bands of 20 MHz (i.e., two carriers). The term carrier aggregation is then also used. Another example, again, is the aggregation of a 4G link and a Wi-Fi link within a mobile terminal (mobile telephone or tablet, for example). Also, within a residential gateway (box), the aggregation of a DSL link such as an Ethernet link and a radio link such as a 3G/4G link of the mobile terminal of the subscriber to these two services is known.

The aggregation of two DSL links of two residential gateways of two subscribers of a same Internet Service Provider via a Wi-Fi connection established between these two devices when they are located within radio range of each other, may be considered as a new extension of the above examples. A case of use that may be envisaged is the situation in which two such boxes respectively installed in two neighbouring buildings, for example two residential houses, and each having an Ethernet link making it possible to connect to servers of the Internet network, are within radio range of each other with the result that they can communicate via Wi-Fi. The Ethernet link of one of the subscribers may then be aggregated with that of his neighbour, via the Wi-Fi connection between the two boxes.

However, in such a context, potentially enlarged to more than two residential gateways within range of each other, a risk of creating cross links has been identified if no precaution is taken, as has been described in the introduction of the present description. Embodiments of the invention provide a solution for eliminating or at least reducing this risk significantly.

As a non-limiting example, the present description will be given hereafter with reference to a network device which is a residential gateway (i.e., a box). Residential gateways today play an important role by connecting domestic networks to the Internet. The considered boxes here have, each, an interface for the connection to the domestic network of the corresponding user, namely a local area network (LAN). They also each have one or more other interfaces, of which at least one interface for communication with another similar box, and at least one other interface to communicate with the Internet or another wide area network (WAN).

Each interface of the box is two-directional: it has an inbound link and an outbound link. The terms “inbound” and “outbound” are here used with reference to the exchange of data from the point of view of the box. For upstream data transfer (for data transfer from the LAN to the WAN), the inbound link of the LAN interface and the outbound link of the WAN interface are used. For downstream data transfer (from the WAN to the LAN), it is the opposite: the inbound link of the WAN interface and the outbound link of the LAN interface are used.

The interface which enables a box to communicate with another similar box may comprise links originating from, or to, a public network, for example a link to a community wireless network.

Examples of wireless networks are, notably:
Mobile telephone networks, public or professional, such as the GSM 3G/4G (LTE) public network:
Wireless Local Area Networks (WLAN) such as the Wi-Fi (802.11) or hiperLAN 2 (High Performance Radio LAN 2.0); or instead,
Wireless Personal Area Networks (WPAN) (with a low range of the order of several tens or so metres, such as ZigBee (also known as IEEE 802.15.4) or Bluetooth (also known as IEEE 802.15.1);
etc.

But it may also be a physical link (wired for example) freely accessible by third party devices, such as a PLC (Power Line Carrier) link on the electrical supply network of a dwelling, a building or even a district, or other (see for example IEEE 1901).

Also, the link between the two boxes is not necessarily a link open to the public in the wide sense. It may be a Wi-Fi link established between two subscribers who decide to share their resources for access to a network such as the Internet, for example two neighbours living in a same street or in the same district of a town or a village, and who exchange access codes for this purpose. Also, the link between the two network devices, by Wi-Fi or other, may be defined by default between two residential gateways provided by a same Internet Service Provider (ISP), which sees therein the possibility of extending the Quality of Service (QoS) in a transparent manner for each subscriber.

It is obviously understood that the invention may apply to any type of device with different combinations of interfaces in number equal to or greater than two, which are capable of being aggregated to increase the throughput of communications. This plurality of interfaces may comprise Ethernet, CPL, Wi-Fi. 3G/4G interfaces, etc., from the moment that they offer respective links to the Internet capable of being aggregated via a link between two devices, to increase the throughput of each device (or of one at least of such devices) during the connection to the Internet or to another wide area network (WAN), for example.

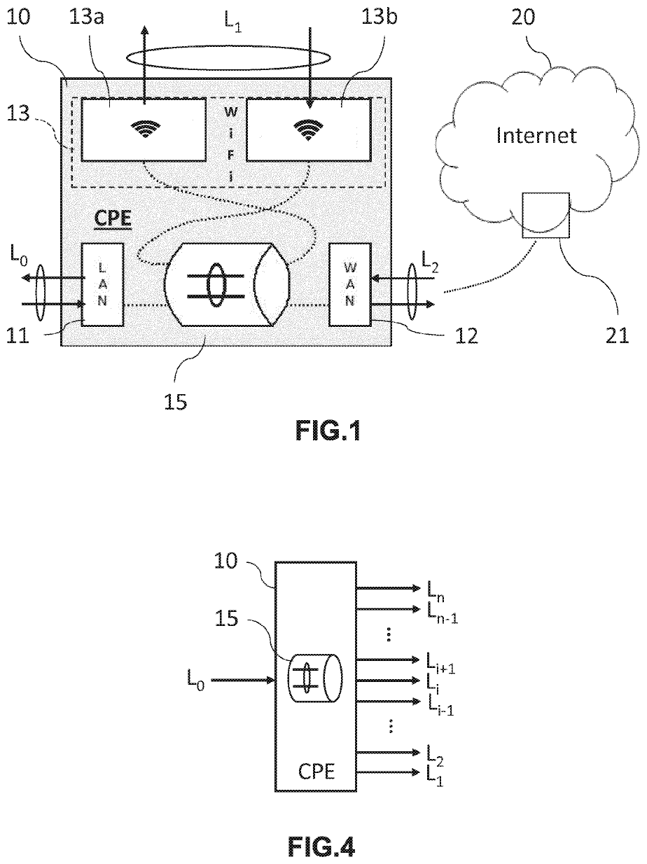

With reference to the diagram of FIG. 1, an example of such a residential gateway 10 (CPE) may comprise a first Ethernet interface 11 to communicate with a local area network (LAN), not represented, a second Ethernet interface 12 to communicate with a wide area network (WAN) such as the Internet 20, and a Wi-Fi interface 13 to communicate wirelessly with other similar devices. In the embodiments, these other devices supporting the Wi-Fi are capable of connecting to the gateway 10 when they are within radio range.

The gateway 10 implements link aggregation to communicate with a host in the network 20, via an aggregation point 21 somewhere in said network. More particularly, link aggregation is here implemented between the respective Ethernet links 12 of two identical or similar devices using the Wi-Fi link between these two devices. More particularly, the box 10 comprises an aggregation engine 15 receiving the

[symbol]

It will be noted that the aggregation point is not systematically the same for all of the devices capable of participating in the formation of loops.

In the context of the implementation of the data routing method according to the embodiments of the invention, a gateway such as the gateway 10 shown in FIG. 1 may thus communicate with a host in the network 10 directly via the Ethernet interface 12, but also indirectly via an Ethernet interface of another identical or similar network device with which it communicates through Wi-Fi.

The appearance of technologies such as Wi-Fi indeed offers to Internet users the possibility of transforming their private access point into a public, or at least shared, hotspot. Indeed, each Internet user can offer other Internet users the possibility of using all or part of his bandwidth to communicate with the Internet via his Wi-Fi network. The residential gateway of a private individual may thus become a Wi-Fi hotspot open to all users present in the radio coverage zone. This possibility is presently encouraged by certain Internet Service Providers (ISP) within the community of their clients/subscribers. They see therein the means to increase the bandwidth available for each of their subscribers by pooling the access points of several amongst them. The residential gateways require capacities which inexorably swell with the increase in multimedia data traffic, the multiplication of cloud applications and the rise in throughput of accesses (sometimes above 100 Mbit/s). This increased complexity results in a higher occurrence of technical problems, which generates an increase in costs for the service providers, in particular with home interventions.

In this context, the invention proposes a solution to the problem consisting in the risk of formation of crossings of links between two network devices (CPE) which both implement link aggregation, with at the least two links:
an outbound link to the other network device such as the outbound link L₁ of the interface 13 (Wi-Fi interface) of the device 10 of FIG. 1; and
at least one other outbound link such as the outbound link L₂ of the interface 12 (WAN interface) of the device 10 of FIG. 1, which is capable of reaching an aggregation point such as the aggregation point 21 of FIG. 1, in the network 20.

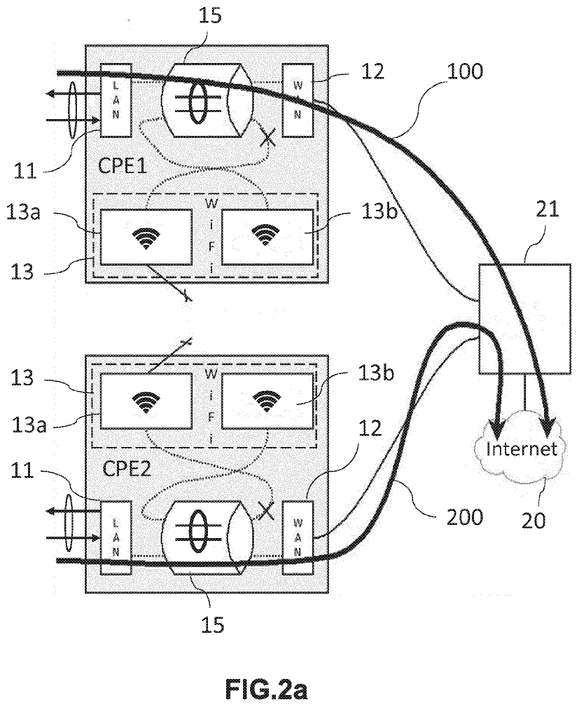

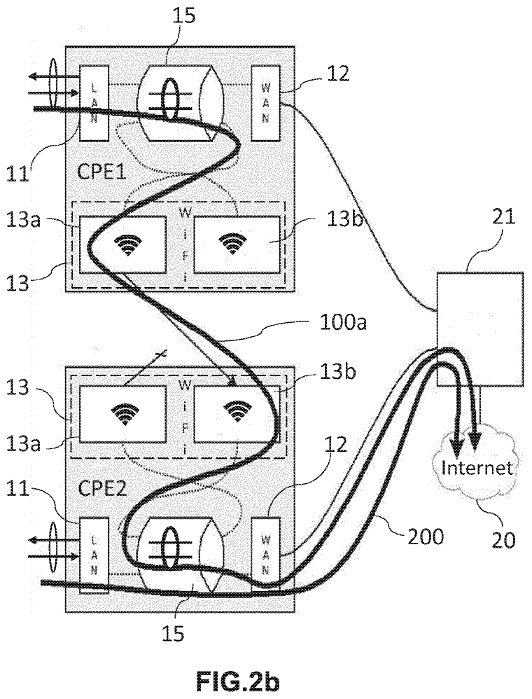

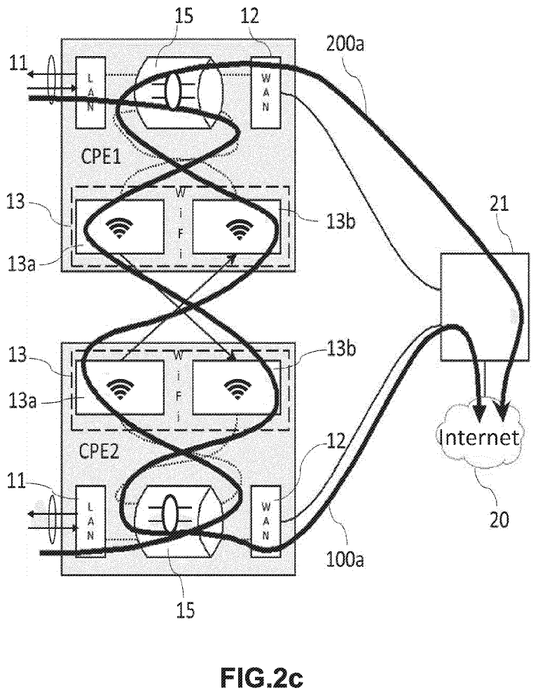

FIGS. 2A-2C illustrate the different paths that data can follow between a first residential gateway CPE1 and a second residential gateway CPE2 such as that of FIG. 1 both implementing link aggregation, when each has an outbound link direct to the Internet and another outbound link to reach the Internet via the other gateway. For example, this may be the fact of being a client to the public Wi-Fi of a residential gateway situated in the neighbourhood.

It is this latter link which may be behind data crosstalk between the gateways CPE1 and CPE2, as will now be described. Indeed, if an outbound link of a device implementing link aggregation has for destination a device which can also perform link aggregation with a direct link to the Internet and another link which only reaches the Internet indirectly through the source device, then this outbound link may be behind the creation of crosstalk.

In FIGS. 2A-2C, the path covered by the data stream 100 from the gateway

CPE1 to reach the aggregation point in the Internet as well as the path covered by the data stream 200 from the gateway CPE1 to reach the same or another aggregation point in the Internet, are both represented by a thick line.

With reference to the diagram of FIG. 2A, the aggregation engine of the gateway CPE1 may take the decision to only use the outbound link L₂, i.e. the outbound link of the WAN Ethernet interface to reach directly the aggregation point 21 in the Internet 20. The same decision may be taken by the aggregation engine of the other gateway CPE2, as regards the routing of its data to the Internet. In such a case, there is no crosstalk between the boxes CPE1 and CPE2. The two boxes each exploit their own WAN access. It will be noted that this situation is identical to that which exists if the two boxes CPE1 and CPE2 are no longer connected to each other by their Wi-Fi interface, for whatever reason.

In the case of FIG. 2B, the aggregation engine of the gateway CPE1 takes the decision to use not only the outbound link L₂, i.e. the outbound link of the WAN Ethernet interface, but also the outbound link L₁, i.e. the link that enables it to reach directly the aggregation point 21 in the Internet 20, namely via the Ethernet link of the other CPE2 gateway. Put another way, the outbound links L₁ and L₂ of the CPE1 gateway are aggregated. It will be noted that only the sub-stream 100a of data from the box CPE1 which transits through the other box CPE2 is represented in FIG. 2B, in order not to overload the figure to the detriment of its legibility. The other sub-stream, which reaches the Internet 20 directly from the box CPE1 via its WAN interface, is not represented. In such a case, there is no crosstalk either between the two boxes CPE1 and CPE2. The box CPE1 uses a part of the bandwidth of the link L₂ of the box CPE2 in the context of link aggregation, which makes it possible to increase its communication throughput with the Internet.

But in the case represented in FIG. 2C, on the other hand, crosstalk is created. Indeed, in this example, the aggregation decision taken by the aggregation engine of the gateway CPE1 is the same as in the case presented in FIG. 2B and described above. However, the aggregation engine of the gateway CPE2 also takes for its part the decision, this time, to use not only the outbound link L₂, i.e. the outbound link of the WAN Ethernet interface, but also the outbound link L₁, i.e. the link that enables it to reach indirectly the aggregation point 21 in the Internet 20, namely via the Ethernet link of the gateway CPE1. A crossing is thus formed between the data sub-stream 100a which originates from the box CPE1 and reaches the Internet via the box CPE2, on the one hand, and between the data sub-stream 200a from the box CPE2 which originates from the box CPE2 and reaches the Internet via the box CPE1, on the other hand. It will be noted that the complementary sub-streams originating from each box CPE1 and CPE2 and directly reaching the Internet (i.e., without passing through the other box CPE2 and CPE1, respectively) are not represented so as not to overload FIG. 2C.

This crosstalk causes the drawbacks that have been described in the introduction, and cancels the interest of the link aggregation which manifested itself, for the box CPE1 in the case for example of FIG. 2B.

The embodiments proposed make it possible to avoid that such a situation arises, or at least to limit substantially the risk thereof.

To explain these embodiments, it will be considered that the residential gateway CPE1, at least, implements the method of the invention.

The other gateways may implement or not the method, this does not affect in any way the technical effect and the advantages obtained as regards the data traffic from the box CPE1. Obviously, however, the more the residential gateways implement the method, the better is the overall efficiency of the network.

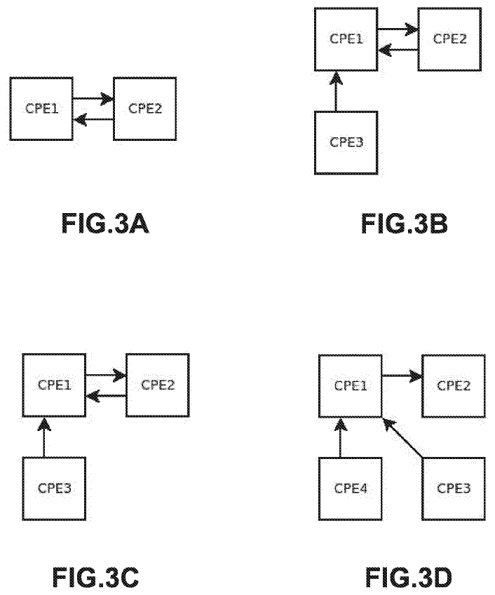

FIGS. 3A-3D are diagrams illustrating different configurations liable to give rise to crosstalk between two residential gateways, or more, such as the residential gateway of FIG. 1.

Crosstalk may take place when two devices CPE1 and CPE2 simultaneously try to perform link aggregation via the other device, namely the box CPE1 via the box CPE2, and the box CPE2 via the box CPE1. The problem may also reappear during more complex configurations, with more than two devices. Generally speaking, each configuration which presents a risk of formation of crosstalk involves a first device that wishes to use the interface of a second device for link aggregation, as well as one or more other devices (of which the second device forms part or not) that wish to perform link aggregation via the first device.

The case of FIG. 3A corresponds to what has been described above with reference to FIGS. 2A-2C. It implements two boxes CPE1 and CPE2. In the case of FIG. 3B and FIG. 3C, a third box CPE3 is involved. Finally, the example of configuration of FIG. 3D includes four boxes, CPE1, CPE2, CPE3 and CPE4. It goes without saying that other more complex configurations may exist, which may generate crosstalk as a function of the decisions taken by the respective aggregation engines of each of these four boxes. Also when even more boxes may be involved.

It will be noted that the topologies that pose a data crosstalk problem are not limited to topologies corresponding to the formation of loops. For example, the topology according to FIG. 3D does not comprise a loop, but it is all the same a problem topology. The topology that poses a problem is a topology in which a box that wishes to perform aggregation via another residential platform while it is itself used by other boxes to perform aggregation. Thus, in the example of FIG. 3D, the box CPE1 benefits from the box CPE2 to perform aggregation. However the boxes CPE3 and CPE4 also benefit from the box CPE1 to perform aggregation, which is not to the advantage of the box CPE1. Indeed, if the box CPE1 has decided to perform aggregation via CPE2, it is precisely because it has need to increase its bandwidth by using that of the box CPE2, such that it is not advisable that it shares its bandwidth with the boxes CPE3 and CPE4.

Those skilled in the art will appreciate that, if in the examples described up to now with reference to FIGS. 2A-AC and 3A-3D there is, for each box CPE1 and CPE2, two outbound links eligible for aggregation, this is a minimum. Indeed, there may be more outbound links eligible for aggregation, there is no limitation at this level. There may be other links capable of being elected in the context of link aggregation (several links such as the links Li of the CPE1 and CPE2 boxes of FIGS. 2A-20) and may thus also give rise to crosstalk. But each box may also comprise links which are connected directly to the Internet (such as the links L₂ of the box CPE1 and CPE2 of FIGS. 2A-2C) or to another device which does not perform link aggregation.

FIG. 4 is thus a simplified diagram of another example of residential gateway 10, with more than two outbound links eligible for link aggregation. In the example represented, there is for example a number n of outbound links L₁, where i is an index comprised between 1 and n. These links L₁ to Lₙ make it possible to connect the box 10 to the Internet, directly or indirectly via other boxes or other devices. In the example represented, the link L₀ is the inbound link through which the box 10 is connected to the domestic network (LAN) of the subscriber.

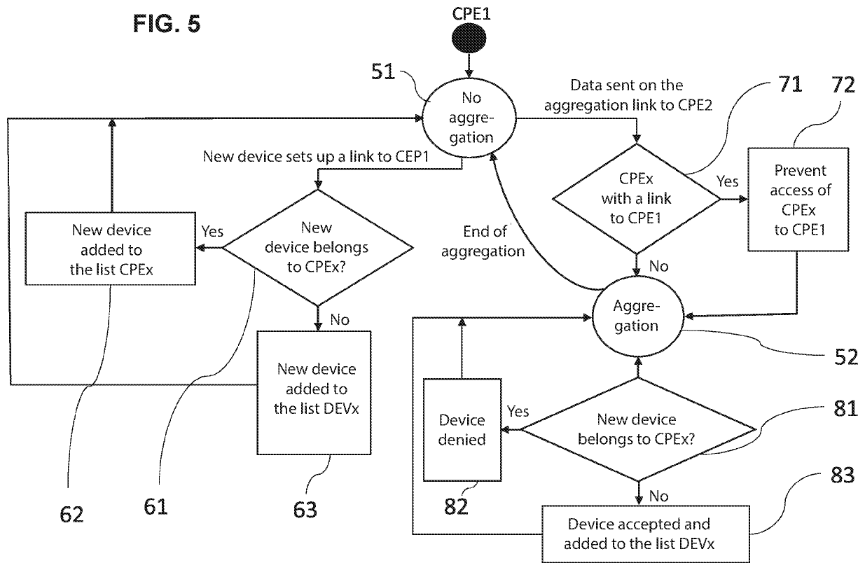

With reference to the diagram of FIG. 5, the steps of the method, which are implemented in the first network device CPE1 of FIGS. 2A-20, i.e. the first box CPE1 described in detail with reference to FIG. 1, will now be described. It is necessary beforehand to introduce the context of this implementation, and to define several notations that will be useful for this presentation. Those skilled in the art will further appreciate that the diagram of FIG. 5 is both a diagram of steps, and a diagram of states.

Indeed two “states” will be considered for the box CPE1, to the effect of the description that follows. In the first state 51, the box CPE1 does not perform link aggregation. Its data are transmitted to the Internet network via the outbound link of its WAN interface. In the second state 52, conversely, the box CPE1 performs link aggregation to transmit its data to the Internet. In the example considered here, the aggregation engine of the box CPE1 will indeed decide to transmit a part of the data stream from CPE1 to the second box CPE2, in order that this sub-stream reaches the aggregation point in the network via the outbound link of the WAN interface of this second box CPE2. Put another way, the box CPE2 is the device to which CPE1 is connected, via a Wi-Fi link in the example, and which is going to receive its aggregated data, that is to say the sub-stream 100b of FIG. 2B.

For ease of reference, CPEx will designate a set comprising, if need be, one or more network devices which are connected to the first box CPE1 by an outbound link, namely still a link of their Wi-Fi interface in the example of FIGS. 1 and 2A-20, and which may wish to perform link aggregation with this outbound link (it will be noted that such devices do not necessarily exist). It is further observed that the box CPE2 may form or not part of the set CPEx. The box CPE1 does not form part thereof.

Moreover, DEVx will designate a set comprising one or more network devices which are connected to the first box CPE1 via the same link as for the devices of the set CPEx, namely in the example the outbound link of their Wi-Fi interface, but for which this link is the main access to the WAN. The devices of the set DEVx do not perform link aggregation. It follows that a device cannot form part both of DEVx and CPEx. All the devices connected to the first box CPE1 that do not belong to CPEx thus form part of DEVx.

The box CPE1 has the capacity of make an inventory of and identify all the other devices that are connected thereto, that is to say the devices that belong to the union of sets CPEx and DEVx. This is enabled, for example, in the case of connections via Wi-Fi, using the possibilities offered by the specifications of the series of norms IEEE 802.11 or ISO/CEI 8802-11. Put another way, those skilled in the art will know how to obtain and upkeep a list of devices of the union of sets CPEx and DEVx without it being necessary to provide them with more explanations here.

Consequently, it will suffice to explain how it is possible to identify network devices belonging to the set CPEx of devices connected by an outbound link to the first box CPE1 and which perform aggregation with this link. This may be done in different ways, at the level of the box CPE1, depending on the implementations considered. Generally speaking, this may be done by detecting if the data received by the box CPE1, via the outbound links of the other boxes that are connected thereto, have already undergone or not an operation of link aggregation upstream of the box CPE1, on the basis of markers present in the data received.

The term “upstream” here refers to the path of the data from the source host that has first emitted the data, and may have transmitted said data directly or indirectly (i.e. via other network devices) to the box CPE1 in the context of one (or more) prior routing operation(s). Indeed, the box CPE2 of FIGS. 2A-20 is not necessarily the host at the origin of the transmission of the data, and may only be a transmission node between source host and destination host in the network 20.

The term “markers” refers for its part to the information present in the data that mark the fact, i.e. which indicate that the data have undergone link aggregation upstream of the box CPE1 in the transmission chain, either in the box CPE2 or in another box from where the data arrive directly, or further upstream of the box CPE2. This generic notion of markers refers to various realities, depending on the embodiments concerned.

Notably, if the MPTCP protocol has been used for link aggregation, then the option field TCP 30 “multipath TCP”, reserved for this purpose by the Internet Assigned Number Authority (IANA), is present in the data received by the box CPE1. The identification of boxes belonging to the set CPEx then comprises the test of the presence of this option field in the data received by CPE1.

If it is the GRE protocol that has been used, then the marker of which the presence in the data received must be tested corresponds to code 47 in the field “protocol” in a header of the IPv4 data packets, or the field “next header” of the final header of the IPv6 data packets, received by CPE1.

These techniques have the defect of being able to generate false positives. Which is why, if it is wished to be free of this drawback, the test may comprise in an alternative or a complement to the two cases above, the test of other markers in the data received by box CPE1 which indicate that these data have undergone link aggregation upstream of the box CPE1.

For example, the test may further comprise a verification of the interface through which the data have entered the box CPE1. This makes it possible to lift the limitations linked to the fact that MPTCP or GRE, respectively, could have been used upstream in the box CPE2 or in another box, in a context other than link aggregation.

In another example, the test may comprise the comparison of the destination IP address of a data packet comprised in the data received by the box CPE1 with the IP addresses contained in a list of IP addresses of the aggregation point 21 in the network, even though obviously these addresses are known to the box CPE1.

In an alternative, the test further comprises (that is to say in addition to the test for the presence of the field TCP 30 “multipath TCP” for MPTCP, or the test of whether the field “protocol” in a header of an IPv4 data packet, or the field “next header” of the final header of an IPv6 data packet, comprised in the data received by the box CPE1 is equal to 47 for GRE), an identifier, known by the box

CPE1, of another device belonging to the set upstream of this box CPE1 and through which the data have transited before reaching the box CPE1. The identifier of this box upstream of the box CPE1 may comprise a physical address in the network that is specific thereto, for example its MAC (Media Access Control) address, and is known to the box CPE1. It may be known to the box CPE1 either in a static manner, or in a dynamic manner because it is communicated to the box CPE1 by a network management protocol such as the TR-069 protocol or the SNMP (Simple Network Management Protocol) which is a communication protocol that allows network administrators to manage the devices of the network, to supervise and to diagnose network and hardware problems remotely.

In an alternative, the test may also be based on an interval of known MAC addresses, for example on the basis of the three first octets of MAC addresses which designate the manufacturer, that is to say the Organizationally Unique Identifier (OUI) managed by the IEEE to ensure the unicity of MAC address numbers.

Another example for the identification of devices of the set CPEx is applicable notably when the link between the devices belonging to the set CPEx which are connected to the box CPE1 and this is a public Wi-Fi link. The protocols of the series 802.11 indeed operate at the level of layer 2 of the OSI model and provide the transmission of three types of wireless frames:
control frames, which aid the delivery of data frames;
management frames, which are used to establish and maintain Wi-Fi communications; and,
data frames, which ensure the actual transport of useful data.

Yet, Wi-Fi clients send management frames of sub-type probe request to determine which access points (APs) are reachable. And the APs respond to the clients with information on their capacities such as the name of the network (SSID), the throughputs supported, the names and manufacturer of the AP, etc.

That is why in an embodiment where the data are received by the device CPE1 via the public Wi-Fi interface, it is possible to provide that the device belonging to the set CPEx which sends aggregated data to the box CPE1 adds a unique identifier to the data. This unique identifier may be, for example, a “vendor specific” tag in the probe requests 802.11, with a value known both by the device CPE1 and by the device CPE2. When the device CPE2 receives a probe request originating from CPE1 with the “vendor specific” tag of agreed value, it associates the fact of receiving the data from the device CPE1 (for example on the basis of its MAC address) on account of the fact that all the data originating from this device have already been aggregated.

A final example that will be given here applies to the case where the device CPE1 plays the role of DHCP (Dynamic Host Configuration Protocol) server vis-a-vis the devices of sets CPEx and DEVx that are connected thereto, in the context of public Wi-Fi. It will be recalled that DHCP (Dynamic Host Configuration Protocol) is a network protocol, the role of which is to ensure the automatic configuration of the IP parameters of a station or a machine, notably by assigning thereto automatically an IP address and a sub-network mask.

Which is why, if the device CPE1 plays the role of DHCP server vis-a-vis devices of the sets CPEx and DEVx in the context of public Wi-Fi, then the devices of the set CPEx which communicate data to the box CPE1 in the context of link aggregation can indicate this fact via a DHCP option (for example the option 60 “vendor class identifier”) with a predefined value and known to CPE1. Thus, the box CPE1 can associate all the data originating from other devices on account of the fact that these data have already been aggregated, that is to say to the fact that the devices concerned belong to the set CPEx.

Those skilled in the art will appreciate that the aforesaid examples may be combined, in order to give a more reliable detection if the data have experienced prior link aggregation.

A particular case is that of a device that would perform aggregation for the first time via the box CPE1, and must thus be added to the list of devices of the set CPEx (while identifying it in a unique manner with its MAC address for example). As long as the device has not performed aggregation, it belongs to the list of devices of the set DEVx. Several techniques (which have the defect of being able to generate false positives) may be used to detect the fact that the device performs aggregation, such as for example the following techniques:
a. If a device sends the MPTCP stream, namely that the option TCP 30 “multipath TCP” is present in a TCP packet received, then the device performs aggregation, and thus belongs to CPEx.
b. If a device sends GRE traffic, namely that the field “prof cool” in a header of an IPv4 data packet, or the field “next header” of the final header IPv6, is equal to 47, then the device performs aggregation, and thus belongs to CPEx.
c. In the case where the IP address or addresses (v4 or v6) of the aggregation point 21 situated in the WAN network and used by the boxes of the set CPEx are perfectly known to the box CPE1, then CPE1 can compare the destination IP address (v4 or v6) of the packet with those contained in the list of IP addresses (v4 or v6) of the aggregation point. If there is correspondence, then the device from which the packet is received performs the aggregation, and thus belongs to the set CPEx.

The algorithm implemented in the box CPE1 will now be described according to the embodiments of the method of the invention, to prevent the devices of the set CPEx from accessing the box CPE1 in the context of aggregation when the aggregation engine of this box CPE1 decides to begin to perform aggregation in the box CPE1 itself in order to discharge its main WAN link and thus increase its throughput to the Internet. In particular, it will be considered what happens when the box CPE1 begins to perform aggregation by directing a part of its data stream to another box to which it is connected, which corresponds in the example considered here to the second box CPE2 of FIGS. 2A-20.

As long as CPE1 does not perform aggregation with its link to CPE2, nothing in particular happens. The box CPE1 is in the state 51 represented in the diagram of FIG. 5.

The case may just arise of a new device which connects to the box CPE1 via its Wi-Fi link to CPE1, whereas it was not already connected thereto. This new device thus enters into the union of sets of CPEx and DEVx devices, but the box CPE1 does not know to which of these two sets this new device henceforth belongs. In order to determine this, the box CPE1 tests, at step 61, if this new device belongs or not to the set CPEx using one of the techniques described above. If yes, then the new device is added to the list of boxes of the set CPEx, at step 62. If not, then it is added to the list of devices of the set DEVx, at step 63. Symbolically, in FIG. 5, the steps 62 and 63 are re-looped on the state 51 of the box CPE1 to indicate that the box CPE1 remains in this state.

It will now be considered what happens when the first box CPE1 which implements the method according to the invention is going to enter into the state 52 where it is going to perform aggregation with its link to the second box CPE2.

Firstly, at step 71 the box CPE1 verifies if devices exist that are connected thereto and which belong to the set CPEx of devices which perform link aggregation thereto by sending to it a part of their data stream. If not, then the box CPE1 can begin to perform stream aggregation without risk of generating crosstalk, which, otherwise, would occur if its aggregation engine decided to send a part of the stream of the box CPE1 to the box CPE2. The box CPE1 then passes into the state 52. If yes, conversely, the risk exists that crosstalk is generated. To prevent this, and thus avoid the associated drawbacks which were mentioned in the introduction of the present description, measures are taken at step 72 to prevent access to the box CPE1 by the boxes of the set CPEx. These measures will be detailed hereafter in this description.

Briefly, what is proposed in accordance with the embodiments of the invention, is to cut the Wi-Fi link which connects the boxes of the set CPEx to the box CPE1. Indeed, the box CPE1 does not control the decisions that are taken at the level of the aggregation engines of the boxes of the set CPEx, but it may take the radical decision of preventing them from being able to address thereto a part of the stream from these boxes, by breaking the link that connects them thereto.

In other words, if the test of step 71 is positive, then the box CPE1 forces the fact that the boxes of the set CPEx no longer have access to the links to the box CPE1.

Once there is no longer any device belonging to the set CPEx that could remain connected to the box CPE1, this box CPE1 passes into the state 52 where it performs link aggregation with the link to the second box CPE2.

In an alternative, it is possible that the box CPE1 begins to perform link aggregation without awaiting the fact that all the devices belonging to the set CPEx no longer have access to CPE1 via their aggregation links. This may be carried out as a background task. The drawbacks associated with the formation of crosstalk are then only temporary, and disappear progressively as the devices of the set CPEx are disconnected from the box CPE1, to disappear totally when none of these devices is no longer connected to the box CPE1.

It will now be described what happens if, while the box CPE1 is in the state 52 wherein it performs link aggregation (with the second box CPE2, or with other devices), a new device sets up a link to the box CPE1.

At step 81, it is firstly determined by the box CPE1 if this new device belongs to the set CPEx of devices which can perform link aggregation with the box CPE1, or belong to the set DEVx of devices which cannot do so. The implementation of this step 81 may once again be based on one of the exemplary techniques that have been described above.

If the new device belongs to the set CPEx, then at step 82 the setting up of the link from this device to CPE1 is denied, or this link is closed, as a function of the implementations. More precisely, the connection is denied if the classification of the new device is carried out before its connection to the box CPE1. And the link is closed if the classification of the new device takes place once said device is connected to the box CPE1 (which can be a necessary evil in the case of the use of some at least of the aforesaid techniques which are based on the analysis of data received to detect if these data are received within the context of the implementation of a link aggregation in the device that sends them): the new device is then disconnected from the box CPE1.

If, conversely, the test of step 81 has for result that the new device belongs to the set DEVx of devices that cannot perform link aggregation via the box CPE1, then there is no risk of having to support the drawbacks of crosstalk. Which is why, at step 83, the connection of this new device is then accepted or confirmed, depending on the case. It is accepted if the classification of the new device takes place before its connection to the box CPE1. And it is confirmed if the classification of the new device takes place once said device is connected to the box CPE1 (more particularly, it is not necessary to take an action, since by hypothesis the new device is already connected in this case).

It will be appreciated that if the box CPE1 stops performing aggregation with another box as a result of a decision taken by its aggregation engine, then the state machine returns to its initial state 51, and the devices of the set CPEx will be once again allowed to connect to CPE1 if they attempt to reconnect thereto. Indeed, the devices belonging to the set CPEx may implement a process by which they periodically attempt to reconnect to the box CPE1 with the hope of again seeing their connection allowed. Obviously, nothing prevents, moreover, that the devices belonging to the set CPEx also attempt to connect to a device other than the box CPE1 (which has the same role as CPE1 in the description that has been given above of embodiments of the invention) if such a device is available.

As has been stated above in the present description with reference to step 72 of the method, implementations of the method comprise the fact of preventing access to the box CPE1 by devices belonging to the set CPEx when the box CPE1 wishes to begin to perform link aggregation (i.e., wishes to pass from the state 51 to the state 52) while the devices belong to the set CPEx of devices which perform or can perform link aggregation with the box CPE1, with the risk of formation of crosstalk. This may be done by different methods.

For example, if a device belonging to the set CPEx is connected by Wi-Fi to the box CPE1 in Wi-Fi station mode, the box CPE1 then playing the role of access point (AP), then the box CPE1 can prevent the Wi-Fi association (or instead force the Wi-Fi disassociation) with the device concerned. It does not appear necessary to describe here an implementation of this example, which is within the reach of those skilled in the art.

According to other applicable examples whatever the physical link connecting a device of the set CPEx to the box CPE1 (namely a Wi-Fi link or any other link), preventing access may be done at the level of layer 3 of the OSI model, for example with the help of the tool iptables under Linux, such as for example with the following command: “iptable-t filter—A FORWARD-m mac-mac-source 00 :11 :22 :33 :44 :55-j REJECT-reject-with icmp-net-unreachable”. This command prevents the device having for MAC address the address 00 :ii :22 :33 :44 :55 of being routed through the box CPE1 The box CPE1 sends back to the device CPEx an ICMP of type “network unreachable” in response to a data transmission attempt. This ICMP is important in order to warn the device concerned of the set CPEx that the box CPE1 does not wish, or no longer wishes, to transmit data from this device. Here, the filter on the MAC address is only an example of criterion that may be used to identify the device belonging to the set CPEx. Other techniques may be implemented, such as those mentioned above.

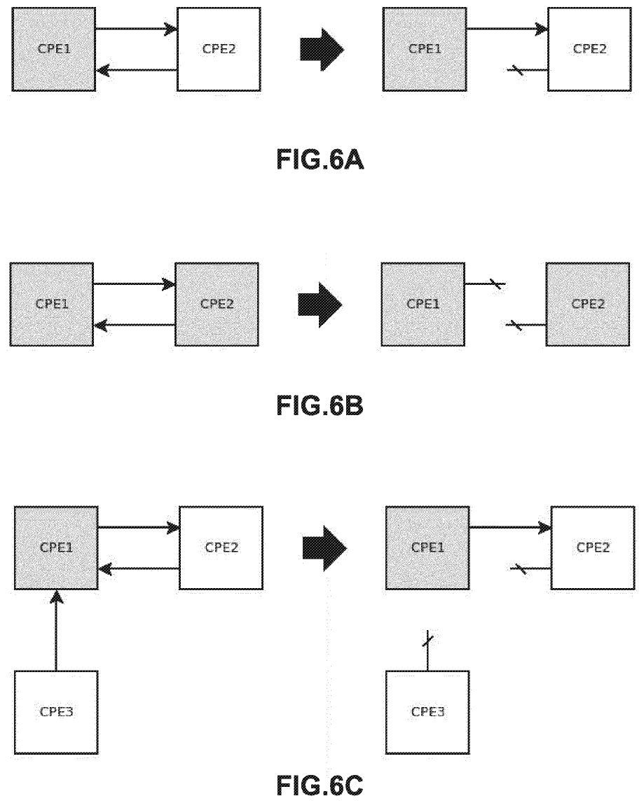

The diagrams of FIGS. 6A-6C illustrate the effects of the implementation of the invention for different exemplary configurations. In each of these figures is shown on the left of the large arrow the situation without the implementation of the invention, and on the right of the large arrow the situation with the implementation of the embodiments of the invention. By convention, in these figures, a device that wishes to perform link aggregation with another device is represented by a square with grey tint/patterns filling, and a device that does wish to perform link aggregation with another device is represented by a square without filling (i.e. a white square). The links established between the devices are represented by simple arrows connecting the corresponding squares. The links to a device that are denied or closed in application of the method according to the embodiments of the invention, are represented by a line extending in the direction of the square representing said device but interrupted without reaching this square. Put another way, the grey CPEs perform aggregation to another CPE by transmitting data along the arrow, whereas the non-grey (i.e., white) CPEs, although connected via an arrow to another CPE, do not send data in application of an aggregation mechanism at the determined instant.

FIG. 6A shows the case of two devices, of which one box CPE1 which wishes to perform link aggregation, and another box CPE2 which does not wish to do so. FIG. 6B shows a configuration with two boxes CPE1 and CPE2 which both wish to perform link aggregation with the other box. FIG. 6C shows a configuration with three devices of which a box CPE1 that wishes to perform link aggregation and two boxes CPE2 and CPE3 which do not wish to do so.

As appears in these figures, from the moment that a determined device such as the box CPE1 wishes to perform link aggregation with one or more other box device such as the box CPE2 (FIGS. 6A and 6B) or such as the boxes CPE2 and CPE3 (FIG. 60), the link(s) that may exist to said determined box CPE1 from the other box or boxes CPE2 or CPE2 and CPE3 without the implementation of the invention, are denied or closed with the implementation of the invention in the box CPE1. In the case of FIG. 6B, each of the boxes CPE1 and CPE2 wishes to perform link aggregation with the other box, thus if each implements the invention then the two links from one to the other and vice versa that exist without the implementation of the invention, are denied or closed with the implementation of the invention in the boxes CPE1 and CPE2.

The present invention has been described and illustrated in the present detailed description and in the appended figures of the drawings, in possible embodiments. The present invention is not limited, however, to the embodiments described. Other alternatives and embodiments may be deduced and implemented by those skilled in the art on reading the present description and the appended drawings.

In the claims, the term “comprises” does not exclude other elements or other steps. A single processor or several other units may be used to implement the invention. The different characteristics described and/or claimed may advantageously be combined. Their presence in the description or in different dependent claims do not exclude this possibility. The reference signs could not be understood as limiting the scope of the invention.

1. A method for managing a connection of a first network device with at least one second network device of a data network, each of said first and second network devices comprising a link aggregation engine implementing a link aggregation technique to select one from among at least a first and a second outbound links participating in the link aggregation in said network device with:
an outbound link for connecting said network device to the other network device; and
at least one other outbound link which is capable of reaching a determined aggregation point in the data network without passing through the other network device,
the method comprising the following steps, implemented in the first network device:
i. deciding by the aggregation engine of the first network device to send data on the outbound link of said first network device which connects it to the second network device;
ii. detecting whether data from the second device and/or from another network device are received, via the outbound link of said second network device and/or the other network device, respectively, which connects it to the first network device, in the context of a link aggregation implemented in said second network device and/or the other network device, respectively, on the basis of markers present in said data; then,
iii. in the affirmative, closing the outbound link of the second network device and/or the other network device which connects it to the first network device; and,
iv. transmitting data on the outbound link connecting the first network device to the second network device in the context of the link aggregation implemented in the first network device.

2. The method according to claim 1, further comprising the determination by the first network device, when any new network device tries to connect to said first network device, of whether data may be received from said new network device in application of a link aggregation implemented in said new network device, on the basis of one or more markers in the data received from said new network device in the context of the procedure for establishing the connection of said new network device to the first network device, or on the basis of one or more markers in the data received from said new network device once said connection has been established.

3. The method according to claim 2 wherein, if the new network device tries to connect to the first network device while said first network device implements link aggregation, and if it is determined that data may be received from said new device in application of a link aggregation implemented in said new network device, then the connection of the new network device to the first network device is denied or it is closed in the case where said connection is already established at the moment where this determination occurs.

4. The method according to claim 1, wherein, the second network device and/or the other network device and/or the new device network using the MPTCP protocol for link aggregation, a marker used in the presence of the option TCP 30 “multipath TCP” in the data received by the first network device, the second network device or the other network device or the new network device, respectively.

5. The method according to claim 1, wherein, the second network device and/or the other network device and/or the new device network using GRE tunnels for link aggregation, a marker used is the value 47 in the field “protocol” in the IP header of an IPv4 data packet, or the field “next header” in the final header of an IPv6 data packet, comprised in the data received by the first network device, originating from the second network device or the other network device or the new network device, respectively.

6. The method according to claim 4, wherein one tests the nature of the interface through which are received, by the first network device, the data received from the second network device and/or the other network device and/or the new network device, for lifting the limitations linked to the fact that MPTCP or GRE, respectively, could have been used in the second network device or in the other network device or in the new network device in a context other than link aggregation.

7. The method according to claim 1, wherein a marker used comprises the destination IP address of a data packet comprised in the data received from the second network device or the other network device or the new network device with IP addresses contained in a list of respective IP addresses of a plurality of aggregation points of the data network and which are known to the first network device.

8. The method according to claim 1, wherein a marker used comprises a unique identifier, known by the first network device, the second network device and/or the other network device and/or the new network device.

9. The method according to claim 8 wherein the unique identifier of the second network device or the other network device or the new network device comprises a physical address in the network which is specific to said second network device or to the network device or to the new network device, respectively, and is known to the first network device either in a static manner or because it is communicated to said first network device by a network management protocol, and wherein the test of the identifier comprises the comparison with an interval of physical addresses known to the first network device.

10. The method according to claim 1, wherein, the data being received from the second network device or the other network device or the new network device via a Wi-Fi IEEE 802.11 interface of the first network device, a marker used comprises a specific value in the attribute number 26 of a frame of type probe request.

11. The method according to claim 1, wherein, the first network device playing the role of DHCP server vis-a-vis the second network device and/or vis-a-vis the other network device and/or vis-a-vis the new network device, a marker used is a DHCP option with a predefined value known to the first network device, the second network device and/or the other network device and/or the new network device, which is inserted by the second network device or by the other network device or by the new network device, respectively, in the data received by the first network device from said second network device or said new network device, respectively, when these data are the subject of a link aggregation in said second network device or in said new network device, respectively.

12. A device for managing the connection of a first network device with at least one second network device, each of said first and second network devices comprising a link aggregation engine implementing a link aggregation technique to select one from among at least a first and a second outbound links participating in link aggregation in said network device with:
an outbound link for connecting said network device to the other network device; and
at least one other outbound link which is capable of reaching an aggregation point in the network without passing through the other network device,
the device comprising, within the first network device:
i. means in the aggregation engine to decide to send data on the outbound link of said first network device which connects it to the second network device;
ii. means for detecting whether data from the second device are received, via the outbound link of said second network device and/or another network device which connects it to the first network device, in the context of a link aggregation implemented in said second network device, on the basis of markers present in said data; then,
iii. means for, in the affirmative, closing the outbound link of the second network device and/or the other network device which connects it to the first network device; and,
iv. means for transmitting data on the outbound link connecting the first network device to the second network device in the context of the link aggregation implemented in the first network device.

13. The device according to claim 12 further comprising means for implementing a method according to all the steps of claim 2.

14. A residential gateway comprising a device according to claim 12.

15. A computer program product directly loadable in the internal memory of a digital computer, comprising software code portions which, when said program is executed by a computer, lead said computer to implement all the steps of the method according to claim 1.

16. A non-transitory data recording support readable by a machine comprising a processor, comprising software code portions to implement the method according to claim 1.
